(19) United States
(12) Patent Application Publication
(10) Pub. No.: US 2008/0183026 A1
(43) Pub. Date: Jul. 31, 2008

(54) TRANSITION UNIT

(76) Inventors: Vernon A. Trigger, (US); Jerry B. Morof, Bloomfield Hills, MI (US); Claire T. Brown, Anderson, SC (US); Marjorie T. Wyman, Ft. Myers, FL (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/861,979

(22) Filed: Sep. 26, 2007

Related U.S. Application Data
(63) Continuation-in-part of application No. 10/217,990, filed on Aug. 13, 2002, now abandoned.

(51) Int. Cl. B09B 3/00

(52) U.S. Cl. 588/250

(57) ABSTRACT

The Alchemic transition unit transforms abiogenic substances into environmentally friendly biogenic substances through a unique arrangement of its components. The transition unit has applications where it is desirable to effectuate the chemical transition of abiogenic, negatively charged chemical compounds by raising them to biogenic ecological energy levels, thus rendering them beneficial and non-toxic.

### CROSS REFERENCE TO RELATED APPLICATIONS

“This application claims priority to U.S. patent application Ser. No. 10/217,990 filed Aug. 15, 2002, the disclosure of which is incorporated by reference in its entirety.”

### FIELD OF THE INVENTION

The present invention relates to an alchemic transition unit for transitioning abiogenic substances into biogenic environmentally acceptable substances.

### BACKGROUND AND SUMMARY OF THE INVENTION

The magnetic resonance spectrum, electromagnetic energy, and the magnetic field of Earth are established by the Earth rotating in an eccentric specific orbit around the Sun. Earth is in electromagnetic and inertial equilibrium with the Sun, and where equilibrium is maintained by compensating adjustments in the ionosphere and magnetosphere.

The equilibrating interface between the biosphere and abiosphere has a neutral magnetic resonance spectrum that is otherwise know as the drift by geologists. The geological drift varies greatly in its position below the surface, from about 400 feet to thousands of feet depending upon the topography of the Earth. When energy is added by emissive magnetic resonance at the higher index points, the unstable substances become discrete compounds in their new locations, on or near the surface of the biosphere. This causes the substance to return to magnetic resonance.

The magnetic resonance of toxic substances opposes the resonances of living cells and nutrients. Anti-resonant signifies direct opposition to, or out of phase with, the substances which support life. By contrast, the emissive magnetic resonances posses a relative motion which is clockwise and spiraling and delivering positive energy. The living DNA double helix is a resultant of such action, with the axis of the helices lying in any coordinate.

Non-life toxic substances that are retrieved from the abiosphere as a result of oil and mineral well drillings are counter clock-wise, anti-DNA rotation (−). The absorptive magnetic resonance possesses relative motion, counter clock-wise, spiraling down the quantum energy scale, detracting energy. Toxic substances steal energy from living molecules which in turn reduces metabolism.

It would be desirable to provide an alchemic transition unit that is energized by electromagnetic forces of the Earth, to bring about the chemical transition of abiogenic, negative chemical compounds by raising them to biogenic ecological energy levels. Thus, making the substance beneficial and non-toxic. It is contemplated that such a transition unit could be used to detoxify foods, water, hazardous wastes, petroleum and other fuel products, the transition of carcinogenic growths into benign tumors, and for reducing viruses. Also, it would be desirable to transition copper, nickel and other toxic contaminated ores, prior to them being refined. These are merely a few samples of the anticipated use of this unique alchemic transition unit.

In order to accomplish the various objects of the present invention, an alchemic transition unit for transforming abiogenic substances into biogenic substances is disclosed. The transition unit includes an outer cylinder that is cylindrically shaped and made of steel. A foundation for supporting the outer cylinder is provided and it contains no metal reinforcements. Grounding rods are connected to the outer cylinder and they extend to a water table. A lower support structure made preferably of wood is located within the outer cylinder. An inner cylinder is supported by the lower support structure. A canister is located within the inner cylinder. A cover is located on the outer cylinder for enclosing the unit.

In another aspect of the present invention, a method of transforming abiogenic substances into biogenic environmentally friendly substances is comprised of the steps of providing an alchemic transition unit having a canister for receiving substances. The initial step is to fill the canister with abiogenic substances such as contaminated coal or some other contaminated substance that needs transformed into a biogenic environmentally acceptable substance. The next step is where the substance is charged with positive energy. This causes the transformation of the abiogenic substances into biogenic substances so that they are environmentally friendly. And finally, the transformed substance is removed from the canister. Raw coal is a sample of a fossil fuel that was transformed by the biosphere becoming toxic. It can be transformed back into biogenic environmentally friendly substances by utilizing the present invention. The abiogenic toxic substances that the present invention can transform include fluids in both gaseous and liquid forms.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side elevational view of an alchemic transition unit that has been located within the ground, where abiogenic substances have been located within a canister for transitioning same into biogenic substances;

FIG. 2 is a top elevational view taken from the direction of Arrow 2-2 as shown in FIG. 1, illustrating the outer cylinder relative to the inner cylinder;

FIG. 3 is a side elevational view of the hoisting cable in the retracted position that is utilized to maneuver the canister to and from the transition unit;

FIG. 4 is a side elevational view of the hoisting cable mechanism in an engaged position showing the canister properly inserted within the inner cylinder;

FIG. 5 is a schematic diagram of the electrical field that is present within the unit; and

FIG. 6 is an alternative embodiment of the present invention, illustrating an alchemic transition unit that is operable to transition abiogenic liquid substances into biogenic liquid substances

### DETAILED DESCRIPTION OF THE PREFERRED EMBODIMENTS

The following description of the preferred embodiment(s) is merely exemplary in nature and is in no way intended to limit the invention, its application, or uses.

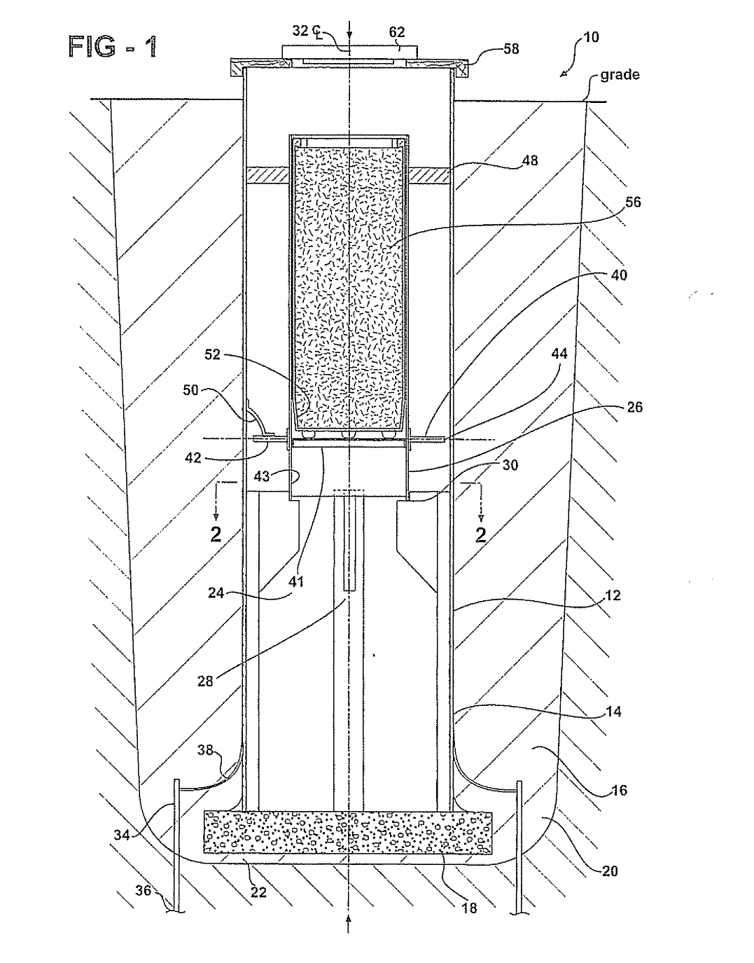

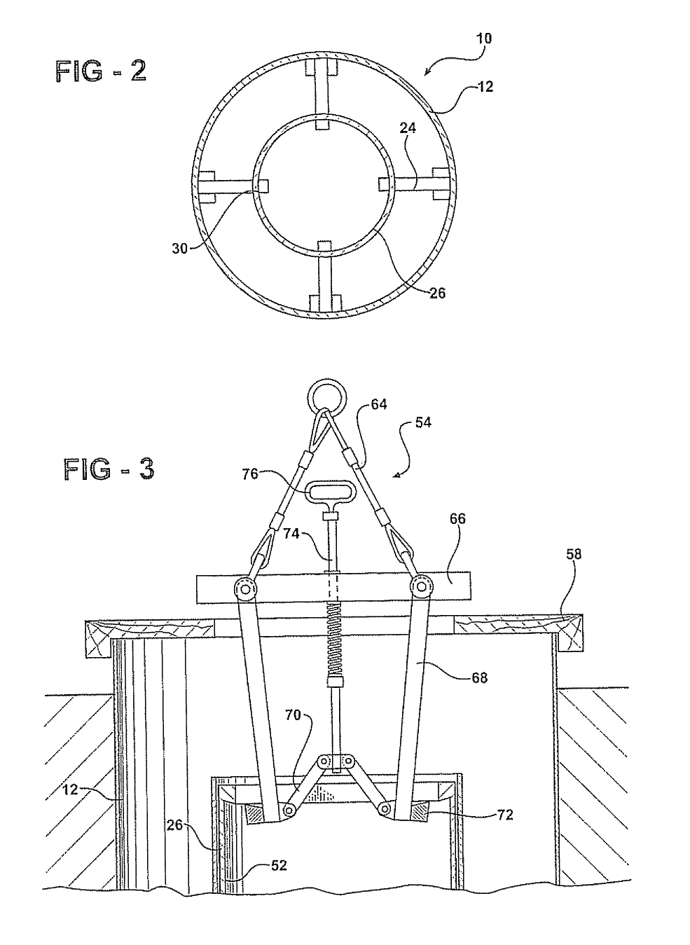

The present invention is an alchemic transition unit 10 for transforming abiogenic substances into biogenic, environmentally friendly substances. The transition unit 10 is an assembly that is preferably located sub grade and is operable to transform solids, and fluids and gasses. A preferred form of the present invention is illustrated in FIG. 1 where a transition unit 10 is shown for use in connection with transforming raw coal from an abiogenic, toxic substance to a biogenic, environmentally friendly substance. It will be appreciated that the unit 10 depicted in FIG. 1 can be modified so as to detoxify other substances, such as foods, water, hazardous waste, oils, coolants, carcinogenic growths, metals, petroleum products, and gases.

The transition unit 10 includes an elongated outer cylinder 12 that is preferably made of magnetic stainless steel. The cylinder 12 is located within a hole 14 in the ground 16 at a position vertical to the ground 16. A concrete slab 18, free of metal, is placed over a vapor barrier on well compacted sand and gravel fill 20. The slab 18 must be perfectly level and a drain sump 22 is positioned below the elevation of the slab 18 for removing water.

A base 24, supported by the slab 18, is located at the lower end of the outer cylinder 12 for supporting an inner cylinder 26. The base 24 includes four separate wings 28 that are offset at 90 degree angles from one another. Each wing 28 is preferably made of wood and the base 24 is centrally positioned within the outer cylinder 12 in order to maintain trueness. A recess 30 at the upper end of each wing provides a centering feature for locating the lower part of inner cylinder 26 precisely in place relative to the centerline 32. The centerline extends axially in the outer cylinder 12 and is vertical to the ground.

A plurality of grounding rods 34 is driven to the water table 36 in order to establish a positive ground. Each grounding rod 34 is connected to the outer cylinder 12 by a copper braid in order to ground the outer cylinder 12.

The inner cylinder 26 is preferably made of non-magnetic stainless steel and has an outside diameter of K and a length of K×Pi. K is a variable and starting point for the configuration and manufacture of the unit 10. K represents the diameter of the inner cylinder. K could be in the range of 10-140 inches in diameter. A flange 40, has a width of K/pi, and is positioned at the lower end of the cylinder 26 at a distance of K/2 from the lower end of the cylinder. The outside diameter of the flange 40 is K+2(K/Pi). The space between the inside diameter of the outer cylinder 12 and the edge of the flange 40 is K/4Pi. The positioning is precise and the flange 40 is preferably made of magnetic silicon steel. A plate 41 located within the cylinder 26 is aligned with a centerline 42 that extends through the flange which is also at a right angle from the wall of the inner cylinder. The Outer cylinder 12 has a midpoint 44 and the inner cylinder 26 is positioned so that the centerline 42 is in alignment. The length of the outer cylinder 12 is (K×2pi)+2(K/4pi) and its inside diameter is K+2(K/pi)+2(K/4pi).

Struts 48 are positioned between the inner wall of the outer cylinder 12 and the outer wall of the inner cylinder 26 for arranging the inner cylinder in a perfectly upright position. The struts 48 are preferably made of wood and are spaced equally around the perimeter of the inner cylinder. Copper wire braids 50 ground the flange 40 to the outer cylinder 12.

A canister 52 for housing substances to be transformed is located within the inner cylinder 26. The canister 52 is preferably made of aluminum alloy and has a diameter that is slightly smaller than the inside diameter of the inner cylinder 26 so as to provide a loose fit there between. The canister has an open top that is recessed below the top of the inner cylinder 26. Pads or bumpers made preferably of neoprene are secured to the bottom of the canister 52 for aiding in the insertion of the canister into the inner cylinder and on top of the plate 41.

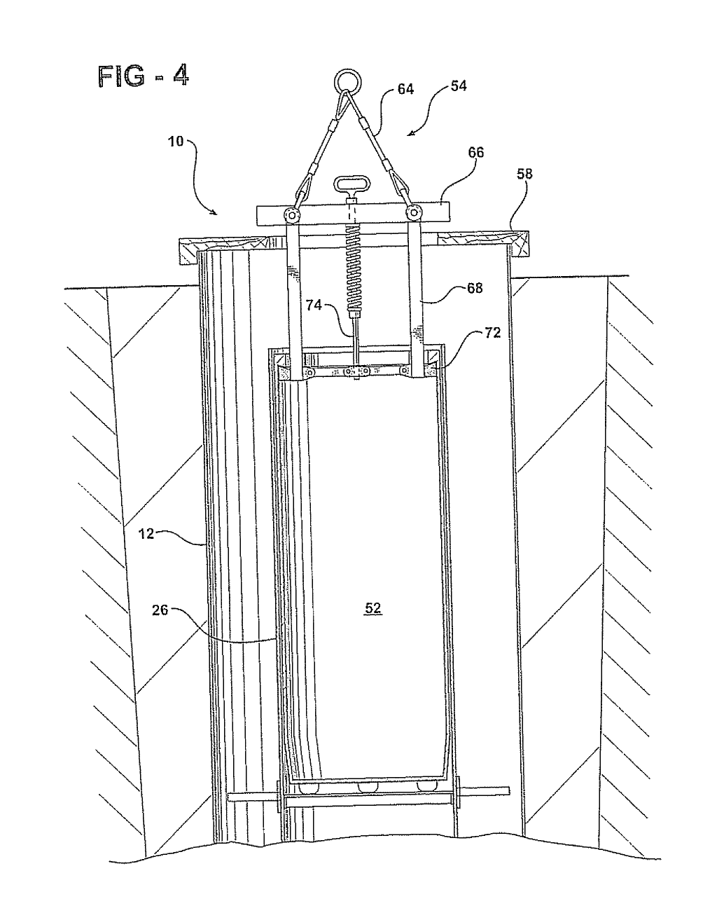

With reference to FIGS. 3 and 4, the canister 52 can be easily removed to and from the unit 10 by a hoist assembly 54. The hoist assembly 54 allows the canister to be removed and substances 56 to be put into the transition unit 10 for processing. A top panel 58 that is preferably made of wood extends over the opening of the outer cylinder 12. An access hole 60 in the top panel 58 can be accessed by removing cover 62. Once the cover 62 is removed, the hoist can be lowered within the outer cylinder 12 to facilitate maneuvering of the canister 52.

The hoist assembly 54 includes cables 64 that in turn are connected to a plate 66. Suspension bars 68 are pivotally connected to the plate 66 at one end, and at the other end to linkage rods 70. Lifting bars 72 extend outwardly from the suspension bars 68 for engaging an inner surface of the canister 52. The inner and outer movement of the lifting bars 72 is effectuated by a control rod 74 that extends vertically through the plate 66. A handle 76 connected to the control rod 74 allows an operator to lift the rod 74 into a disengaged position as shown in FIG. 3, or to an engaged position as shown in FIG. 4. When the hoist assembly is in the engaged position, the canister 52 can be maneuvered to or from the transition unit 10. The Unit 10 can be reused repeatedly by removing the canister 52 from the inner cylinder 26. Thus, the canister is not permanently placed into the ground 16. This flexibility allows the Unit 10 to be used over and over again such that a variety of substances 56, toxic or otherwise, can be placed in the canister 52. The processed substances 56 can be solid or liquid and generally initially are in toxic form. The canister 52 is operable of being repeatedly removed from the inner cylinder 26, filled with a substance 56, and relocated within the inner cylinder.

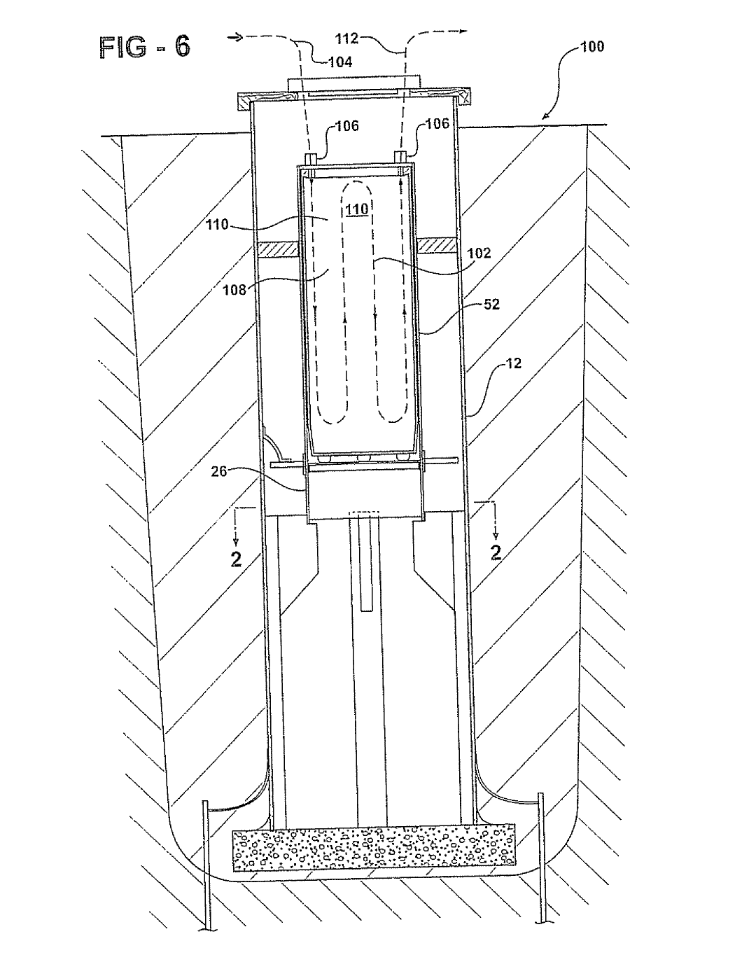

FIG. 6 depicts an alternative alchemic transition unit 100 for transforming toxic fluids to a biogenic environmentally friendly substance. The unit 100 is designed substantially the same as the unit 10 as previously discussed, except that unit 100 is operable to specifically handle fluids. Unit 100 includes an outer cylinder 12, a slab 18, grounding rods 34, a base 24, and inner cylinder 26 and a canister 52. However, the new aspects are the fluid means 102 that transports fluid to and from the unit 100. An inlet 104 provides a supply of fluid, or even a gas, into the unit 100 by means of piping. Connectors 106 allow for quick disconnect of the fluid lines from the canister 52. Within the canister 52 are circulation lines 108 that pass the incoming contaminated fluids through a field 110. An outlet 112 transports the now biogenic, environmentally friendly fluid, from the unit 100 to where it can now be used. It will be appreciated that the units 10 and 100 can be modified to handle other forms of toxic substances by modifying their size and configuration.

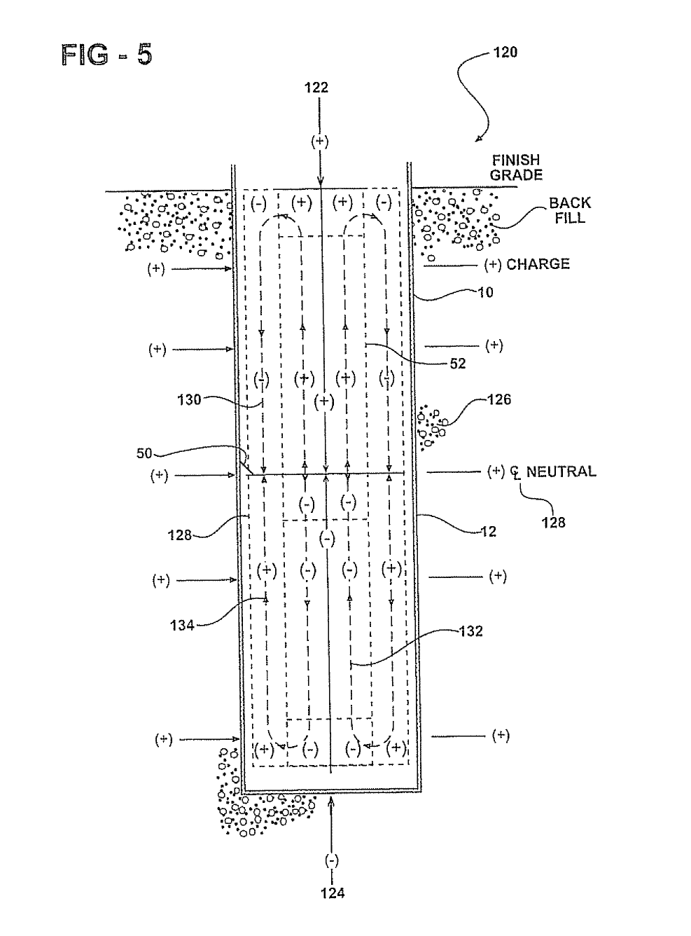

FIG. 5 depicts a schematic diagram of the force field 120 that is exerted on the transition unit 10. Positively charged emissive magnetic resonances 122 originate from space and are exerted downward on the transition unit 10. Opposing absorptive magnetic resonances 124 are 180 degrees out of phase from the emissive magnetic resonance 122 and are negatively charged. The absorptive magnetic resonances 124 emit from the center of the Earth and impinge upon the lower part of the unit 10. Earth 126 is back filled against the outer cylinder 12 which is positively charged about its perimeter. A neutral line 128 extends centrally. There are outer boundaries 128 of the rotating spiral magnetic resonance fluxes 110. Negative absorptive magnetic resonances 132 flow counter to the positive emissive magnetic resonance 134. The Negative absorptive magnetic resonances 132 remove energy from the biosphere and from living cells. The inner cylinder 52 receives charging electromagnetic energy by the cable connection 50 from the outer cylinder to the equilibrating interface of the inner cylinder located at the mid-elevation of the outer cylinder.

The description of the invention is merely exemplary in nature and, thus, variations that do not depart from the gist of the invention are intended to be within the scope of the invention. Such variations are not to be regarded as a departure from the spirit and scope of the invention.

1-22. (canceled)

23. A re-useable transition unit for the pre-treatment of substances, comprising:
an outer cylinder made of magnetic material that is cylindrically shaped and made of steel;
a foundation for supporting the outer cylinder;
grounding rods connected to the outer cylinder and extending to a water table;
a lower support structure located within the outer cylinder;
an inner cylinder made of non-magnetic material, said inner cylinder being supported by the lower support structure; and
a canister located within the inner cylinder, said canister is operable of being repeatedly removed from the inner cylinder, filled with a substance, and relocated within the inner cylinder;
wherein the inner cylinder is operable to permit the transmission of electromagnetic energy to a material contained within the canister, the material contained within the inner cylinder is pretreated and then removed from the transition unit.

24. The transition unit as claimed in claim 1, further comprising a cover located on the outer cylinder.

25. The transition unit as claimed in claim 1, wherein the unit is located substantially underground.

26. The transition unit as claimed in claim 1, further comprising a drain sump adjacent the outer cylinder.

27. The transition unit as claimed in claim 1, wherein the outer cylinder is positioned vertical to the earth.

28. The transition unit as claimed in claim 1, further comprising struts positioned between the outer cylinder and the inner cylinder in order to maintain the inner cylinder in an upright position.

29. The transition unit as claimed in claim 1, further comprising a wire braid extending between the outer cylinder and the inner cylinder for maintaining continuity there between.

30. The transition unit as claimed in claim 1, wherein the lower support structure includes four wing members offset 90 degrees from one another.

31. The transition unit as claimed in claim 1, wherein the inner cylinder includes a flange located around a perimeter of the inner cylinder.

32. The transition unit as claimed in claim 9, wherein the flange has a center line and the outer cylinder has a centerline extending normal to the outer cylinder, the centerlines coincide with one another.

33. The transition unit as claimed in claim 1, further comprising a hoist mechanism that is operable to engage the inner cylinder.

34. The transition unit as claimed in claim 11, wherein the hoist mechanism includes a top plate, suspension bars extending downward from the plate, and lifting bars for engaging the inner cylinder.

35. The transition unit as claimed in claim 1, further comprising a hoist having a control rod that is connected to linkage rods for positioning lifting bars in place to lift the canister.

36. The transition unit as claimed in claim 11, wherein the transition unit is operable to process solids or liquids.

37. The transition unit as claimed in claim 1, further comprising fluid handling means for delivering a toxic fluid to the canister and removing a non-toxic fluid from the canister after transformation thereof.

38. The transition unit as claimed in claim 1, further comprising a fluid circulation system for transforming toxic fluids into non-toxic fluids.

39. A re-useable device for pre-treating toxic substances, comprising:
an inner cylinder made of magnetic material having an outside diameter of K and a length of K×Pi, the inner cylinder being supported by a base, wherein K is a linear measurement;
an outer cylinder comprised of non-magnetic material having an inside diameter of K+2(K/Pi)+2(K/4 Pi);
a foundation for supporting the outer cylinder;
grounding rods connected to the outer cylinder and extending to a water table; and
a canister located within the inner cylinder, said canister is operable of being positioned repeatedly in and out of the inner cylinder;
wherein the inner cylinder is operable to permit the transmission of electromagnetic energy to a material contained within the canister.

40. The device as claimed in claim 17, wherein the outer cylinder has a length of (K×2Pi)+2(K/4Pi).
